(19) United States
(12) Patent Application Publication
(10) Pub. No.: US 2019/0293152 A1
(43) Pub. Date: Sep. 26, 2019

(54) TRANSMISSION

(71) Applicant: AISIN AI CO., LTD., Nishio-shi (JP)

(72) Inventors: Yosuke HAYASHI, Toyota-shi (JP); Takeshige MIYAZAKI, Chiryu-shi (JP); Daisuke SAITO, Okazaki-shi (JP); Atsushi SUZUKI, Kota-cho (JP)

(73) Assignee: AISIN AI CO., LTD., Nishio-shi (JP)

(21) Appl. No.: 16/296,327

(22) Filed: Mar. 8, 2019

(30) Foreign Application Priority Data
Mar. 26, 2018 (JP) 2018-059033

(51) Int. Cl. F16H 3/089; F16C 3/02; F16D 11/02

(52) U.S. Cl. CPC F16H 3/089; F16H 2003/0818; F16D 11/02; F16C 3/02

(57) ABSTRACT

According to one embodiment, a transmission includes a first shaft, a first gear pair, a second gear pair, a synchronization mechanism, and a clutch mechanism. A first sleeve of the synchronization mechanism is movable along the axis of the first shaft between a pressing position, in which the first sleeve presses a second cone surface of a synchronizer ring against a first cone surface of a third gear of the second gear pair, and a non-pressing position in which the first sleeve does not press the second cone surface against the first cone surface. The clutch mechanism transmits rotation between the first shaft and a first gear of the first gear pair and transmits no rotation between the first shaft and the third gear. The clutch mechanism transmits rotation between the first shaft and the first gear while the first sleeve moves from the non-pressing position to the pressing position.

### CROSS-REFERENCE TO RELATED APPLICATIONS

This application is based upon and claims the benefit of priority from Japanese Patent Application No. 2018-059033, filed on Mar. 26, 2018, the entire contents of which are incorporated herein by reference.

### FIELD

Embodiments described herein relate generally to a transmission.

### BACKGROUND

Conventionally, transmissions have been known that include an input shaft, an output shaft, gear pairs including a drive gear relatively rotatably attached to the input shaft and a driven gear fixed to the output shaft, and a clutch mechanism for selecting a gear to which power is transmitted (for example, disclosed in Japanese Laid-open Patent Application No. 2013-24391 and German Laid-open Patent Application No. 102013108300A1).

It is preferable to prevent occurrence of no transmission of power between the input shaft and the output shaft at the time of a gear shift.

An object of the present invention is to provide a transmission which can prevent occurrence of no transmission of power between two shafts with the gears, for example, at the time of a gear shift.

### SUMMARY

In general, according to one embodiment, a transmission includes a rotatable first shaft; a rotatable second shaft parallel to the first shaft; a first gear pair including a first gear and a second gear, the first gear being attached to the first shaft rotatably with respect to the first shaft, the second gear being attached to the second shaft, to be engaged with the first gear and rotate together with the second shaft; a second gear pair including a third gear and a fourth gear and being smaller in gear ratio than the first gear, the third gear being attached to the first shaft rotatably with respect to the first shaft, the fourth gear being attached to the second shaft, to be engaged with the third gear and rotate together with the second shaft; a synchronization mechanism that is switchably placed in a power transmission state and a power shutoff state, the power transmission state being a state that the synchronization mechanism comes between the first shaft and the third gear, and generates frictional force to cause a rotation speed of the first shaft to approach a rotation speed of the third gear, the power shutoff state being a state that the synchronization mechanism generates no frictional force; and a clutch mechanism that switches a rotation transmission state between the first shaft and the first gear and between the first shaft and the third gear, wherein the synchronization mechanism includes: a first cone surface of the third gear, to rotate together with the third gear; a synchronizer ring including a second cone surface to be pressed against the first cone surface to generate the frictional force with the first cone surface; and a first sleeve that is movable between a pressing position and a non-pressing position in an axial direction of the first shaft and rotates together with the first shaft, the pressing position being a position in which the first sleeve presses the second cone surface against the first cone surface, the non-pressing position being a position in which the first sleeve does not press the second cone surface against the first cone surface; and the first sleeve is movable from the non-pressing position to the pressing position while the clutch mechanism transmits rotation between the first shaft and the first gear and transmits no rotation between the first shaft and the third gear; and the clutch mechanism transmits rotation between the first shaft and the first gear while the first sleeve moves from the non-pressing position to the pressing position.

With this structure, for example, the clutch mechanism transmits rotation between the first shaft and the first gear and transmits no rotation between the first shaft and the third gear. The first sleeve is movable from the non-pressing position to the pressing position, and the clutch mechanism can transmit rotation between the first shaft and the first gear while the first sleeve moves from the non-pressing position to the pressing position. Thereby, it is possible to prevent occurrence of no transmission of power between the first shaft and the second shaft at the time of a gear shift from the first gear to the 2-speed gear.

According to the transmission, for example, one of the first shaft and the first gear transmits power of a motor generator to the other of the first shaft and the first gear through the clutch mechanism, and the first shaft and the first gear are rotated in a first rotation direction by the power, and the clutch mechanism includes a one-way clutch that is located between the first shaft and the first gear, transmits rotation from the one to the other in the first rotation direction, and allows rotation of the other with respect to the one in the first rotation direction.

With such a structure, the one-way clutch can transmit rotation between the first shaft and the first gear while the first sleeve moves from the non-pressing position to the pressing position.

According to the transmission, for example, the first gear pair and the second gear pair are spaced apart from each other in the axial direction of the first shaft. The clutch mechanism includes first gear teeth that rotate together with the first gear; second gear teeth that rotate together with the third gear; a first movable member that: includes third gear teeth, is located between the first gear and the third gear and movable between a first mesh position and a first non-mesh position in the axial direction of the first shaft, and rotates together with the first shaft, the first mesh position being a position in which the third gear teeth are engaged with the first gear teeth, the first non-mesh position being a position in which the third gear teeth are not engaged with the first gear teeth, the first non-mesh position being closer to the third gear than the first mesh position; a second movable member that: includes fourth gear teeth, is located between the first gear and the third gear and movable between a second mesh position and a second non-mesh position in the axial direction of the first shaft, rotates together with the first shaft, and presses the second cone surface against the first cone surface while moving from the second non-mesh position to the second mesh position, the second mesh position being a position in which the fourth gear teeth are engaged with the second gear teeth, the second non-mesh position being a position in which the fourth gear teeth are not engaged with the second gear teeth, the second non-mesh position being closer to the first gear than the second mesh position; and a driver that: couples the first movable member and the second movable member, generates force to move the first movable member toward the first non-mesh position while the second movable member is located in the second non-mesh position and the first movable member is located in the first mesh position, moves the first movable member to the first non-mesh position by the force, along with motion of the second movable member toward the second mesh position to press the second cone surface against the first cone surface.

With such a structure, the first movable member can transmit rotation between the first shaft and the first gear while the first sleeve moves from the non-pressing position to the pressing position.

### BRIEF DESCRIPTION OF THE DRAWINGS

FIG. 1 is an exemplary drawing illustrating a schematic configuration of a vehicle according to a first embodiment;

FIG. 2 is an exemplary block diagram illustrating a schematic configuration of the vehicle according to the first embodiment;

FIG. 3 is an exemplary timing chart illustrating exemplary operations of the vehicle according to the first embodiment;

FIG. 4 is an exemplary drawing illustrating a schematic configuration of a vehicle according to a second embodiment; and

FIG. 5 is an exemplary drawing illustrating a schematic configuration of a vehicle according to a third embodiment.

### DETAILED DESCRIPTION

Exemplary embodiments of the present invention will be disclosed hereinafter. In the specification, ordinal numbers are used for distinguishing components, parts, and regions, and are not intended to represent order or priority. The following embodiments include similar or same constituent elements. The similar or constituent elements are denoted by the same reference numerals, and an overlapping explanation thereof is omitted.

### First Embodiment

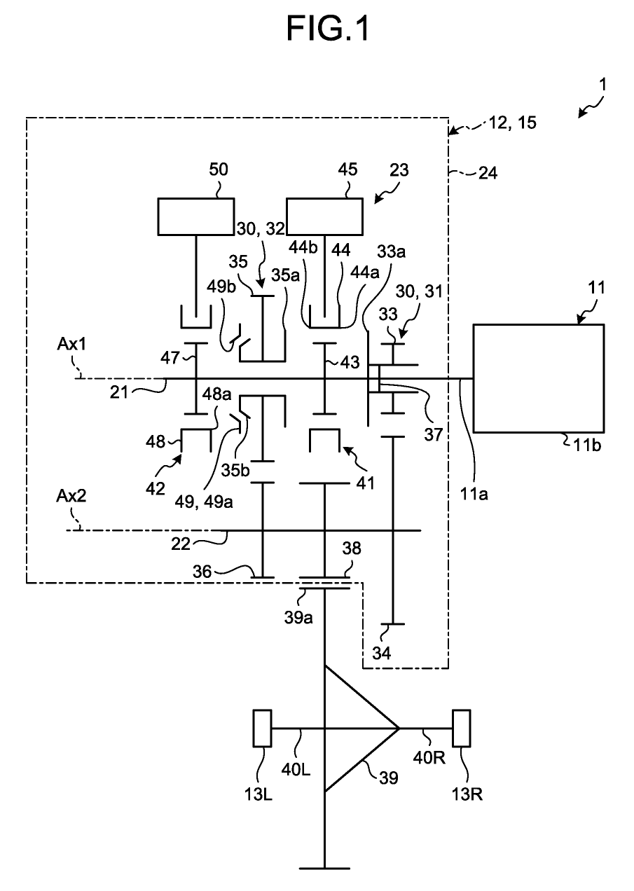

FIG. 1 is an exemplary drawing illustrating a schematic configuration of a vehicle 1 according to a first embodiment. As illustrated in FIG. 1, the vehicle 1 includes a motor generator 11 serving as a driving power source, a transmission 12, wheels 13L and 13R being driving wheels, and wheels (not illustrated) being driven wheels. The vehicle 1 runs by transmitting the power of the motor generator 11 to the wheels 13L and 13R through the transmission 12 to rotate the wheels 13L and 13R.

The motor generator 11 includes a shaft 11a and a case 11b. The shaft 11a is supported by the case 11b rotatably around a first rotation axis Ax1. The case 11b is supported by the body (not illustrated) of the vehicle 1. The case 11b contains a rotor (not illustrated) that rotates together with the shaft 11a, and a stator (not illustrated) surrounding the outer circumference of the rotor. The motor generator 11 applies torque (power) around the first rotation axis Ax1 to the shaft 11a by applying voltage (current).

The transmission 12 is located between the motor generator 11 as the input and the wheels 13L and 13R as the output. The transmission 12, while coupled with the motor generator 11, is supported by the vehicle body.

The transmission 12 includes an input shaft 21, an output shaft 22, multi-speed gears 30, a gear connection mechanism 23, and a case 24. The input shaft 21, the output shaft 22, the multi-speed gears 30, and the gear connection mechanism 23 are contained in the case 24. The case 24 is supported by the vehicle body. The input shaft 21 is an exemplary first shaft, and the output shaft 22 is an exemplary second shaft.

The input shaft 21 and the output shaft 22 are spaced apart from each other in parallel. The input shaft 21 is supported by the case 24 rotatably around the first rotation axis Ax1, and the output shaft 22 is supported by the case 24 rotatably around the second rotation axis Ax2. The first rotation axis Ax1 and the second rotation axis Ax2 are also referred to as rotational axes.

The input shaft 21 is connected to the shaft 11a of the motor generator 11, and rotated together with or in coordination with the shaft 11a. Hereinafter, a rotation direction of the input shaft 21 during forward traveling of the vehicle 1 is referred to as normal rotational direction. The shaft 11a and the input shaft 21 are not necessarily connected directly, and may be connected together through another rotation transmission member, such as a gear, a coupling, or a belt. The rotation speed of the shaft 11a is not necessarily the same as the rotation speed of the input shaft 21.

The multi-speed gears 30 represent constantly meshing gears, extending across the input shaft 21 and the output shaft 22. The multi-speed gears 30 differ in gear ratio (deceleration ratio). The gears are also referred to as gear trains or gear pairs.

The multi-speed gears 30 includes a 1-speed gear 31 and a 2-speed gear 32. The 1-speed gear 31 and the 2-speed gear 32 are spaced apart from each other in the direction of the first rotation axis Ax1 of the input shaft 21. The 2-speed gear 32 is smaller in gear ratio than the 1-speed gear 31. The 1-speed gear 31 is also referred to as a low gear, and the 2-speed gear 32 is also referred to as a high gear.

The 1-speed gear 31 includes a drive gear 33 and a driven gear 34 to be engaged with each other, and the 2-speed gear 32 includes a drive gear 35 and a driven gear 36 to be engaged with each other. The drive gear 33 is an exemplary first gear, the driven gear 34 is an exemplary second gear, the drive gear 35 is an exemplary third gear, and the driven gear 36 is an exemplary fourth gear.

The drive gears 33 and 35 are supported by the input shaft 21 rotatably with respect to the input shaft 21 via bearings (not illustrated), to rotate around the first rotation axis Ax1. The drive gears 33 and 35 are restricted from moving in the direction of the first rotation axis Ax1.

The transmission 12 includes a one-way clutch 37 between the drive gear 33 of the 1-speed gear 31 and the input shaft 21. The one-way clutch 37 prevents the input shaft 21 from rotating with respect to the drive gear 33 in the normal rotational direction. Thus, the one-way clutch 37 can transmit normal rotation from the input shaft 21 to the drive gear 33. The one-way clutch 37 allows relative rotation of the drive gear 33 with respect to the input shaft 21 in the normal rotational direction. Through the one-way clutch 37, the power of the motor generator 11 is transmitted from the input shaft 21 to the drive gear 33, rotating the input shaft 21 and the drive gear 33 in the normal rotational direction. The normal rotational direction is an exemplary first rotational direction.

The driven gears 34 and 36 are fixed to the output shaft 22 to rotate together around the second rotation axis Ax2.

The output shaft 22 is also provided with a final gear 38. The final gear 38 is fixed to the output shaft 22, and rotates together around the second rotation axis Ax2. The final gear 38 is engaged with a differential ring gear 39a located on the case of a differential gear 39. The differential gear 39 is connected to the wheels 13L and 13R through drive shafts 40L and 40R.

The gear connection mechanism 23 includes a clutch mechanism 41 and a synchronization mechanism 42. The clutch mechanism 41 and the synchronization mechanism 42 are spaced apart from each other. Specifically, the clutch mechanism 41 and the synchronization mechanism 42 are independently operable.

The clutch mechanism 41 is located between the drive gear 33 of the 1-speed gear 31 and the drive gear 35 of the 2-speed gear 32. The synchronization mechanism 42 is placed on the same side as the drive gear 35, opposite the drive gear 33. That is, the drive gear 35 is located between the clutch mechanism 41 and the synchronization mechanism 42.

The clutch mechanism 41 serves as a dog clutch mechanism to selectively switch a connection (coupled state) and a disconnection (non-coupled state) between the input shaft 21, and the drive gear 33 of the 1-speed gear 31 and the drive gear 35 of the 2-speed gear 32. Specifically, the clutch mechanism 41 switches transmission and non-transmission of the rotation between the input shaft 21 and the drive gears 33 and 35.

The clutch mechanism 41 includes a hub 43 and a sleeve 44. The clutch mechanism 41 also includes the one-way clutch 37. The hub 43 is coupled with the input shaft 21 to rotate together around the first rotation axis Ax1. The sleeve 44 is coupled with the hub 43 by spline coupling to rotate together around the first rotation axis Ax1, and is movable with respect to the hub 43 along the axis of the input shaft 21. That is, the sleeve 44 rotates around the first rotation axis Ax1 together with the input shaft 21, and is movable with respect to the input shaft 21 along the axis of the input shaft 21.

The sleeve 44 is located between the drive gear 33 of the 1-speed gear 31 and the drive gear 35 of the 2-speed gear 32. The sleeve 44 is an exemplary second sleeve.

The sleeve 44 includes gear teeth 44a and gear teeth 44b. The gear teeth 44a are arranged around the first rotation axis Ax1 at an end (the right end in FIG. 1) of the sleeve 44 on the drive gear 33 side. The gear teeth 44a are engageable with gear teeth 33a of the drive gear 33. The gear teeth 33a are located on a part (the left part in FIG. 1) of the drive gear 33 on the sleeve 44 side to rotate together with the drive gear 33. The gear teeth 44b are arranged around the first rotation axis Ax1 at an end (the left end in FIG. 1) of the sleeve 44 on the drive gear 35 side. The gear teeth 44b are engageable with gear teeth 35a of the drive gear 35. The gear teeth 35a are located on a part (the right part in FIG. 1) of the drive gear 35 on the sleeve 44 side to rotate together with the drive gear 35. The gear teeth 33a, 35a, 44a, and 44b serve as dog teeth. The gear teeth 33a are exemplary first gear teeth, the gear teeth 35a are exemplary second gear teeth, the gear teeth 44a are exemplary third gear teeth, and the gear teeth 44b are exemplary fourth gear teeth.

The sleeve 44 is movable with respect to the input shaft 21 along the axis of the input shaft 21. Specifically, the sleeve 44 is movable to a 1-speed mesh position (not illustrated), a non-mesh position (FIG. 1), and a 2-speed mesh position (not illustrated).

In the non-mesh position (FIG. 1) the gear teeth 44a of the sleeve 44 are not engaged with the gear teeth 33a of the drive gear 33 and the gear teeth 44b of the sleeve 44 are not engaged with the gear teeth 35a of the drive gear 35. The 1-speed mesh position is located closer to the drive gear 33 (the right side in FIG. 1) than the non-mesh position, and at the 1-speed mesh position the gear teeth 44a of the sleeve 44 are engaged with the gear teeth 33a of the drive gear 33. The 2-speed mesh position is located closer to the drive gear 35 (the left side in FIG. 1) than the non-mesh position, and in the 2-speed mesh position the gear teeth 44b of the sleeve 44 are engaged with the gear teeth 35a of the drive gear 35. That is, the sleeve 44 is not coupled with the drive gear 33 and the drive gear 35 in the non-mesh position, coupled with the drive gear 33 in the 1-speed mesh position, and coupled with the drive gear 35 in the 2-speed mesh position. The non-mesh position is also referred to as neutral position.

While the sleeve 44 moves from the non-mesh position (FIG. 1) to the 2-speed mesh position (the left side in FIG. 1), the sleeve 48 presses a synchronizer ring 49 (described later) toward the drive gear 35, to press a cone surface 49b of the synchronizer ring 49 against a cone surface 35b of the drive gear 35.

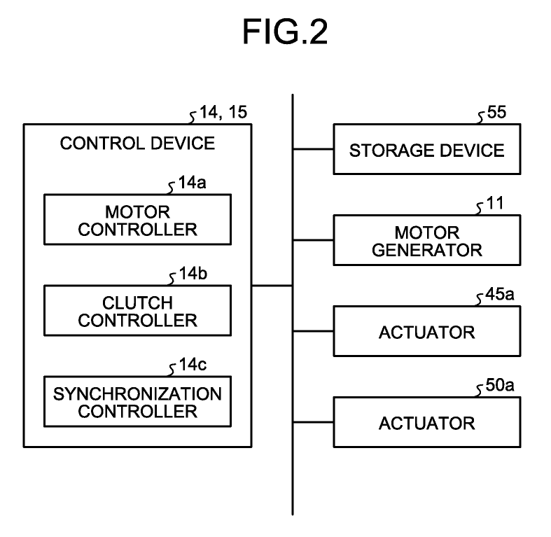

A first movement mechanism 45 selectively places the sleeve 44 in one of the 1-speed mesh position with the drive gear 33, the 2-speed mesh position with the drive gear 35, and the non-mesh position. The first movement mechanism 45 includes an actuator 45a (FIG. 2), such as a motor, and a transmission mechanism (not illustrated) to transmit the driving force of the actuator 45a to the sleeve 44.

While the sleeve 44 is engaged with the drive gear 33 in the 1-speed mesh position, the input shaft 21 and the drive gear 33 are integrally rotatable. This forms a 1-speed rotation transmission path from the input shaft 21 to the drive gear 33, the driven gear 34, the output shaft 22, the final gear 38, the differential gear 39 to the drive shafts 40L and 40R. In the present embodiment, the one-way clutch 37 allows the input shaft 21 and the drive gear 33 to be rotatable together in the normal rotational direction. Specifically, during forward traveling of the vehicle 1, both the one-way clutch 37 and the clutch mechanism 41 transmit rotation or power from the input shaft 21 to the drive gear 33. The ratio at which the one-way clutch 37 and the clutch mechanism 41 transmit the power may be optionally set. During forward traveling of the vehicle 1, the clutch mechanism 41 may transmit no power while the sleeve 44 is located in the 1-speed mesh position. During backward traveling of the vehicle 1, the one-way clutch 37 transmits no power, and the clutch mechanism 41 transmits power from the input shaft 21 to the drive gear 33.

While the sleeve 44 is engaged with the drive gear 35 in the 2-speed mesh position, the input shaft 21 and the drive gear 35 are rotatable together. This forms a 2-speed rotation transmission path from the input shaft 21 to the drive gear 35, the driven gear 36, the output shaft 22, the final gear 38, the differential gear 39 to the drive shafts 40L, 40R.

As described above, the clutch mechanism 41 is selectively switchable among a 1-speed engagement in which the gear teeth 44a of the sleeve 44 of the 1-speed gear 31 are engaged with the gear teeth 33a of the drive gear 33 to rotate the input shaft 21 and the drive gear 33 together, a 2-speed engagement in which the gear teeth 44b of the sleeve 44 are engaged with the gear teeth 35a of the drive gear 35 of the 2-speed gear 32 to rotate the input shaft 21 and the drive gear 35 together, and a non-engagement in which the gear teeth 44a are not engaged with the gear teeth 33a, and the gear teeth 44b are not engaged with the gear teeth 35a, allowing relative rotation among the input shaft 21, the drive gear 33, and the drive gear 35. Specifically, in the non-engagement, the one-way clutch 37 allows the drive gear 33 to normally rotate with respect to the input shaft 21.

The synchronization mechanism 42 is located between the input shaft 21 and the drive gear 35. The synchronization mechanism 42 is switchably placed in a power transmission state (friction generating state) to generate frictional force so that the rotation speed of the input shaft 21 approaches the rotation speed of the drive gear 35, and in a power shutoff state (no friction generating state) to generate no frictional force. By the frictional force, the synchronization mechanism 42 can synchronize the rotation of the drive gear 35 with the rotation of the input shaft 21.

The synchronization mechanism 42 includes a hub 47, a sleeve 48, and a synchronizer ring 49. The hub 47, the sleeve 48, and the synchronizer ring 49 are opposite the sleeve 44 and the drive gear 33 across the drive gear 35. The sleeve 48 is an exemplary first sleeve.

The synchronizer ring 49 is located between the sleeve 48 and the drive gear 35, rotatable with respect to the drive gear 35, and movable along the axis of the input shaft 21.

The synchronizer ring 49 includes a pressed part 49a and a cone surface 49b. The pressed part 49a is a flat annular face around the first rotation axis Ax1. The pressed part 49a can contact the sleeve 48 and be pressed by the sleeve 48. The cone surface 49b is slidable with the cone surface 35b of the drive gear 35 in the circumferential direction of the first rotation axis Ax1. The cone surface 35b integrally rotates with the drive gear 35. The cone surface 49b is pressed against the cone surface 35b by the sleeve 48 to generate frictional force with the cone surface 35b. The cone surface 35b is an exemplary first cone surface, and the cone surface 49b is an exemplary second cone surface.

The hub 47 is coupled with the input shaft 21 to rotate together around the first rotation axis Ax1.

The sleeve 48 includes a pressing part 48a that presses the pressed part 49a of the synchronizer ring 49. The pressing part 48a is a flat annular face around the first rotation axis Ax1. The sleeve 48 is coupled with the hub 47 by spline coupling, rotates around the first rotation axis Ax1 together with the hub 47, and is movable with respect to the hub 47 along the axis of the input shaft 21. That is, the sleeve 48 rotates around the first rotation axis Ax1 together with the input shaft 21, and is movable with respect to the input shaft 21 along the axis of the input shaft 21.

Specifically, the sleeve 48 is movable along the axis of the input shaft 21 between a pressing position (not illustrated) in which the sleeve 48 contacts the synchronizer ring 49 and a non-pressing position (FIG. 1) in which the sleeve 48 is away from the synchronizer ring 49. In the non-pressing position, the pressing part 48a is apart from the pressed part 49a, so that the sleeve 48 does not press the cone surface 49b against the cone surface 35b. In the pressing position, the pressing part 48a contacts the pressed part 49a, so that the sleeve 48 presses the cone surface 49b against the cone surface 35b. The pressing position is closer to the drive gear 35 (the right side in FIG. 1) than the non-pressing position. The sleeve 48 is moved between the pressing position and the non-pressing position by a second movement mechanism 50. The second movement mechanism 50 includes an actuator 50a (FIG. 2), such as a motor, and a transmission mechanism (not illustrated) that transmits the driving force of the actuator 50a to the sleeve 48. The non-pressing position is also referred to as a neutral position.

In the pressing position, the sleeve 48 presses the cone surface 49b against the cone surface 35b, placing the synchronization mechanism 42 in the power transmission state. In the non-pressing position, the sleeve 48 does not press the cone surface 49b against the cone surface 35b, placing the synchronization mechanism 42 in the power shutoff state.

In the transmission 12 with the above structure, the sleeve 48 is movable from the non-pressing position to the pressing position, while the clutch mechanism 41 transmits the rotation between the input shaft 21 and the drive gear 33 and transmits no rotation between the input shaft 21 and the drive gear 35. While the sleeve 48 moves from the non-pressing position to the pressing position, the clutch mechanism 41 can transmit the rotation between the input shaft 21 and the drive gear 33.

FIG. 2 is an exemplary block diagram illustrating a schematic configuration of the vehicle 1 according to the present embodiment. As illustrated in FIG. 2, the vehicle 1 includes a control device 14. The control device 14 and the transmission 12 constitute a power transmission system 15.

The control device 14 is connected to the motor generator 11, the actuator 45a of the first movement mechanism 45, and the actuator 50a of the second movement mechanism 50. The control device 14 controls the motor generator 11 and the actuators 45a and 50a. The control device 14 is also connected to a storage 55 and various sensors (not illustrated).

The control device 14 represents, for example, an electronic control unit (ECU) including a processor, such as a central processing unit (CPU). The processor of the control device 14 executes computation by the program installed in the storage 55 to execute various types of processing. The control device 14 may include hardware, such as a field programmable gate array (FPGA) and an application specific integrated circuit (ASIC) to control the respective elements by the hardware.

The control device 14 includes a motor controller 14a, a clutch controller 14b, and a synchronization controller 14c, as functional elements. The processor of the control device 14 executes the program installed in the storage 55 to thereby implement these functional elements. In the embodiment, part or all of the functional elements may be implemented by dedicated hardware such as circuitry. The motor controller 14a controls the motor generator 11, the clutch controller 14b controls the clutch mechanism 41, and the synchronization controller 14c controls the synchronization mechanism 42.

The storage 55 includes, for example, a read only memory (ROM) and a random access memory (RAM). The storage 55 may also include a hard disk drive (HDD) and/or a solid state drive (SSD). The various sensors include a sensor that measures the value of the speed of the vehicle 1, a sensor that measures the amount of step-on to the accelerator pedal, and sensors that sense the positions of the sleeves 44 and 48.

The following describes one example of operation to be executed by the control device 14, that is, acceleration transmission operation at the time of a gear shift from the 1-speed gear 31 to the 2-speed gear 32 during acceleration of the vehicle 1 traveling forward.

The control device 14 executes acceleration transmission operation in response to increase in a driver's step-on (stroke) to the accelerator pedal. In the operation, at the time of a shift from the 1-speed gear 31 to the 2-speed gear 32 during the acceleration of the vehicle 1, the control device 14 controls the motor generator 11, the synchronization mechanism 42, and the clutch mechanism 41 to allow the acceleration of the vehicle 1 to constantly exceed zero. In addition, during shifting from the 1-speed gear 31 to the 2-speed gear 32, the control device 14 controls the motor generator 11, the synchronization mechanism 42, and the clutch mechanism 41 such that at least one of the synchronization mechanism 42 and the clutch mechanism 41 transmits power between the input shaft 21 and the output shaft 22, and that the motor generator 11 constantly generates torque during the period from the operation start points of the synchronization mechanism 42 and the clutch mechanism 41 to the time when the synchronization mechanism 42 is placed in the power transmission state.

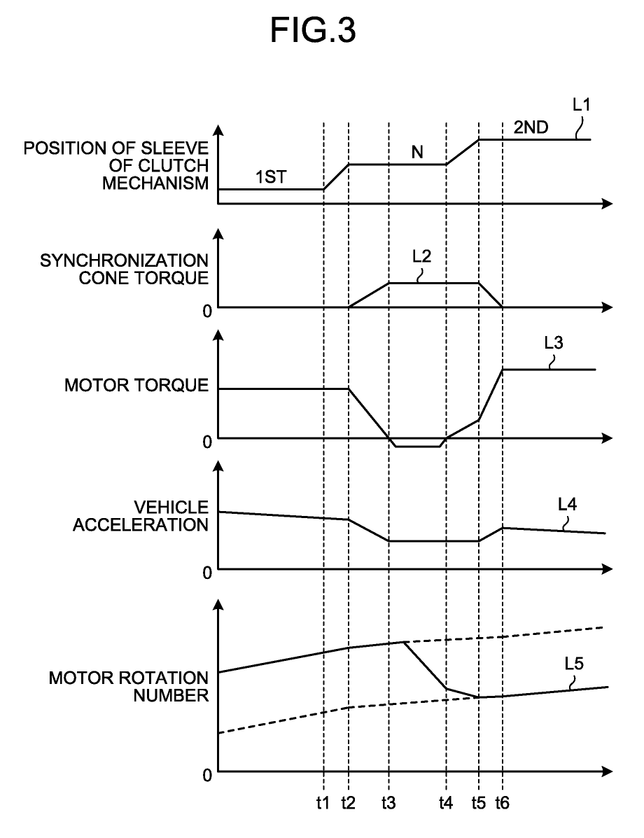

The following will describe the acceleration transmission operation in detail with reference to FIG. 3. FIG. 3 is an exemplary timing chart illustrating an exemplary operation of the vehicle 1 according to the present embodiment.

In FIG. 3, a line L1 represents change in position of the sleeve 44 of the clutch mechanism 41. A line L2 represents change in torque (hereinafter also referred to as synchronization cone torque) transmitted between the cone surface 49b of the synchronizer ring 49 and the cone surface 35b of the drive gear 35. A line L3 represents change in torque (hereinafter also referred to as motor torque) generated with the motor generator 11. A line L4 represents change in acceleration of the vehicle 1. A line L5 represents change in the number of rotations or rotational speed of the shaft 11a of the motor generator 11. The rotational speed of the input shaft 21 changes as the line L5. In FIG. 3, the time passes from time t1 to time t6.

In the example of FIG. 3, before time t1, the sleeve 44 is located in the 1-speed mesh position (1ST in FIG. 3), and the 1-speed gear 31 is selected. In this case, before time t2, the sleeve 48 is not located in the pressing position, therefore, the synchronization mechanism 42 generates no synchronization cone torque. In addition, before time t2, the control device 14 applies a given positive voltage or current to the motor generator 11 to accelerate the vehicle 1. This increases the rotation speed of the shaft 11a of the motor generator 11 over time.

While the 1-speed gear 31 is selected, for example, when the rotation speed of the shaft 11a of the motor generator 11 reaches a given rotation speed, the clutch controller 14b controls the actuator 45a of the first movement mechanism 45 to move the sleeve 44 from the 1-speed mesh position (1ST) to the non-mesh position (N in FIG. 3). Thereby, the sleeve 44 starts moving at time t1 from the 1-speed mesh position (1ST) to the non-mesh position (N), and reaches the non-mesh position (N) at time t2. Time t1 is the operation start time of the clutch mechanism 41. As described above, from time t1 to time t2, the sleeve 48 is not located in the pressing position, thus, the synchronization mechanism 42 generates no synchronization cone torque. In such situation, the sleeve 44 can move from the 1-speed mesh position (1ST) to the non-mesh position (N) because both the one-way clutch 37 and the clutch mechanism (the hub 43 and the sleeve 44) or the one-way clutch 37 alone transmit the rotation or power from the input shaft 21 to the drive gear 33. During the period from time t2 to time t4 the sleeve 44 is located in the non-mesh position (N).

The synchronization controller 14c controls the actuator 50a of the second movement mechanism 50 to allow the synchronization mechanism 42 to start generating the synchronization cone torque at time t2. Thereby, as an example, the sleeve 48 of the synchronization mechanism 42 starts moving from the non-pressing position to the pressing position at time t1, and reaches the pressing position at time t2. Time t1 is the operation start time of the synchronization mechanism 42, and at time t2 the synchronization mechanism 42 is placed in the power transmission state. During the period from time t2 to time t5, the synchronization controller 14c controls the actuator 50a to continuously apply the power to the sleeve 48 to move from the non-pressing position to the pressing position. This increases the synchronization cone torque with time (time t2 to time t3). The synchronization cone torque reaches and maintains a given upper limit value (threshold) (time t3 to time t5). The given upper limit value corresponds to the maximum transmissible torque (allowable torque) between the cone surface 49b of the synchronizer ring 49 and the cone surface 35b of the drive gear 35.

Thereafter, at time t4 at which the synchronization cone torque takes the upper limit value, the clutch controller 14b controls the actuator 45a of the first movement mechanism 45 to move the sleeve 44 from the non-mesh position (N) to the 2-speed mesh position (2ND in FIG. 3). Thereby, at time t4 the sleeve 44 starts moving from the non-mesh position (N) to the 2-speed mesh position (2ND), and reaches the 2-speed mesh position (2ND) at time t5. Thus, at time t5, the gear is shifted to the 2-speed gear 32. In the present embodiment, the clutch controller 14b performs such control that the gear is shifted to the 2-speed gear 32 before the synchronization mechanism 42 completely synchronizes the rotation of the drive gear 35 with the rotation of the input shaft 21, in other words, while the drive gear 35 and the input shaft 21 differ in rotation speed (differential rotation).

The synchronization controller 14c controls the actuator 50a to start moving the sleeve 48 from the pressing position to the non-pressing position and start decreasing the synchronization cone torque, substantially concurrently (time t5) with the arrival of the sleeve 44 at the 2-speed mesh position (2ND) and the gear shifting to the 2-speed gear 32. Thereby, the synchronization cone torque decreases to zero at time t6.

During the above control, the motor controller 14a controls the motor generator 11 as follows. Before time t2, that is, before the generation of the synchronization cone torque, the motor controller 14a applies voltage to the motor generator 11 such that the motor torque matches the given first torque. Specifically, the motor controller 14a controls the motor generator 11, the synchronization mechanism 42, and the clutch mechanism 41 to allow the motor generator 11 to constantly generate torque during the period from time t1 being the operation start point of the synchronization mechanism 42 and the clutch mechanism 41 to time t2 at which the synchronization mechanism 42 is placed in the power transmission state.

In addition, the motor controller 14a controls the motor generator 11 to decrease the motor torque from time t2 at which the synchronization cone torque is generated. The motor controller 14a also applies voltage to the motor generator 11 to generate negative motor torque during the period from time t3 to time t4. The motor controller 14a applies, for example, negative voltage to the motor generator 11 to generate negative torque. The generated negative torque applies brakes to the rotation of the shaft 11a of the motor generator 11 and the input shaft 21, causing the rotation speed of the input shaft 21 to approach the rotation speed of the drive gear 35 more quickly.

Then, the motor controller 14a controls the motor generator 11 to increase the motor torque to the given second torque larger than the first torque during the period from time t4 to time t6. Specifically, the motor controller 14a controls the motor generator 11 to increase the motor torque at a higher rate during the period from time t5 to time t6 than during the period from time t4 to time t5.

Under the motor torque control as above, the rotation speed of the shaft 11a of the motor generator 11 rises until past time t3, decreases between time t3 and time t5, and rises again after time t5. When the motor generator 11 is an AC motor generator, motor controller 14a (the control device 14) controls the motor torque and the rotation speed of the motor generator 11 via the inverter.

Through the control and operations of the elements as above, power is constantly transmitted between the input shaft 21 and the output shaft 22 and between the motor generator 11 and the wheels 13L and 13R during the period from time t1 being the start of gear shifting to time t6 being the end of gear shifting. Specifically, from time t1 being the start of gear shifting to time t2 being rising time of the synchronization cone torque of the synchronization mechanism 42, at least the one-way clutch 37 transmits power between the input shaft 21 and the drive gear 33 and between the input shaft 21 and the output shaft 22. During the period from time t2 to time t6, at least the synchronization mechanism 42 transmits, with the synchronization torque, power between the input shaft 21 and the drive gear 35 and between the input shaft 21 and the output shaft 22. During the period from time t5 to time t6, the clutch mechanism 41 also transmits power between the input shaft 21 and the drive gear 35. By such operation, the acceleration of the vehicle 1 exceeds zero during the period from time t1 being the start of gear shifting to time t6 being the end of gear shifting.

As described above, in the transmission 12 according to the present embodiment, the sleeve 48 is movable from the non-pressing position to the pressing position while the clutch mechanism 41 transmits rotation between the input shaft 21 (first shaft) and the drive gear 33 (first gear) and transmits no rotation between the input shaft 21 and the drive gear 35 (third gear). In addition, while the sleeve 48 moves from the non-pressing position to the pressing position, the clutch mechanism 41 can transmit the rotation between the input shaft 21 and the drive gear 33. By such a structure, at the time of a gear shift from the 1-speed gear 31 (first gear pair) to the 2-speed gear 32 (second gear pair) during the acceleration of the vehicle 1, for example, the situation that no power is transmitted between the input shaft 21 and the output shaft 22 (second shaft) is preventable.

In addition, the transmission 12 according to the present embodiment transmits the power of the motor generator 11, for example, from one (input shaft 21, as an example) of the input shaft 21 and the drive gear 33 to the other (drive gear 33, as an example) through the clutch mechanism 41, to normally rotate the input shaft 21 and the drive gear 33 (in first rotation direction) by the power. The clutch mechanism 41 includes the one-way clutch 37 located between the input shaft 21 and the drive gear 33 to transmit normal rotation from the one (input shaft 21) to the other (drive gear 33) and to allow the other (drive gear 33) to normally rotate with respect to the one (input shaft 21). By such a structure, the one-way clutch 37 can transmit the rotation between the input shaft 21 and the drive gear 33 while the sleeve 48 moves from the non-pressing position to the pressing position.

### Second Embodiment

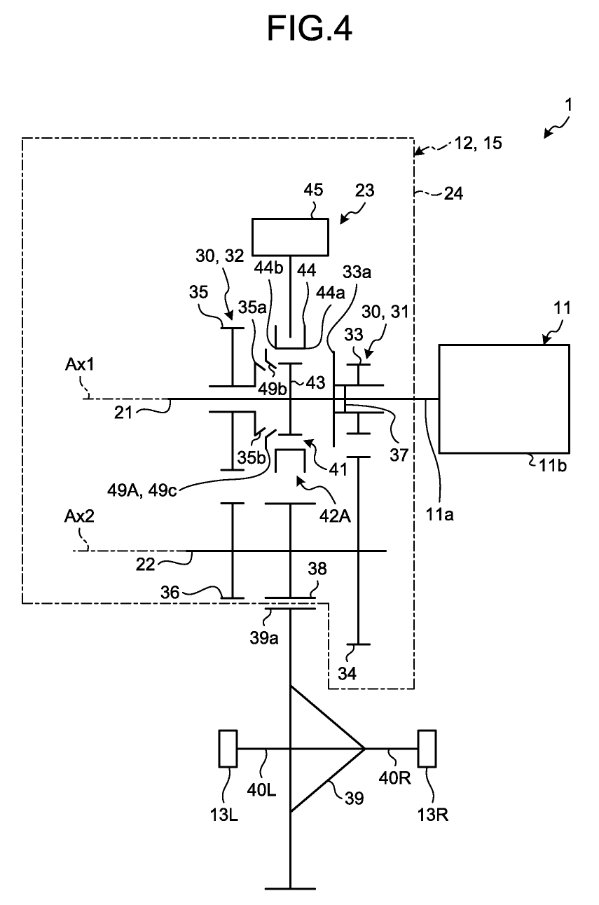

FIG. 4 is an exemplary drawing illustrating a schematic configuration of the vehicle 1 of a second embodiment. The vehicle 1 according to the second embodiment includes a structure similar to that of the vehicle 1 according to the first embodiment. Thus, the second embodiment attains similar effects based on the features similar to those of the first embodiment. The following will mainly describe different features from those of the vehicle 1 of the first embodiment.

In the present embodiment, the transmission 12 includes a synchronization mechanism 42A instead of the synchronization mechanism 42 of the first embodiment. The synchronization mechanism 42A is located between the input shaft 21 and the drive gear 33. As with the synchronization mechanism 42, the synchronization mechanism 42A is switchably placed in the power transmission state, in which the synchronization mechanism 42A comes between the input shaft 21 and the drive gear 35 to generate frictional force to cause the rotation speed of the input shaft 21 to approach the rotation speed of the drive gear 35, and a power shutoff state in which the synchronization mechanism 42A generates no frictional force. By the frictional force, the synchronization mechanism 42A can synchronize the rotation of the drive gear 35 with the rotation of the input shaft 21.

The synchronization mechanism 42A includes a hub 43, a sleeve 44, and a synchronizer ring 49A. Specifically, the hub 43 and the sleeve 44 are commonly used by the synchronization mechanism 42A and the clutch mechanism 41. In addition, in the present embodiment, the synchronization mechanism 42A includes no actuator 50a, instead, the actuator 45a is commonly used by the synchronization mechanism 42A and the clutch mechanism 41. The sleeve 44 is exemplary first sleeve and second sleeve.

The synchronizer ring 49A is located between the sleeve 44 and the drive gear 35 rotatably with respect to the drive gear 35 and is movable along the axis of the input shaft 21.

The synchronizer ring 49A includes a cone surface 49b and gear teeth 49c. The gear teeth 49c includes a chamfer to be pressed by a chamfer of the gear teeth 44b of the sleeve 44. The chamfer of the gear teeth 49c is pressed by the chamfer of the gear teeth 44b of the sleeve 44 moving from the non-mesh position (1-speed mesh position) to the 2-speed mesh position. Thereby, the cone surface 49b is pressed against the cone surface 35b of the drive gear 35, generating frictional force between the cone surface 49b and the cone surface 35b. This position of the sleeve 44 is the pressing position. The frictional force causes the rotation of the drive gear 35 to synchronize with the rotation of the input shaft 21. After the synchronization, the gear teeth 44b of the sleeve 44 pass between the gear teeth 49c of the synchronizer ring 49A and engage with the gear teeth 35a of the drive gear 35. Thus, the sleeve 44, while moving from the non-mesh position to the 2-speed mesh position, pushes the synchronizer ring 49A to press the cone surface 49b against the cone surface 35b. In the present embodiment, the non-mesh position or the 1-speed mesh position is an exemplary non-pressing position.

In the above structure the sleeve 44 is movable from the non-mesh position, that is, the non-pressing position, to the pressing position while the clutch mechanism 41 transmits the rotation between the input shaft 21 and the drive gear 33 and transmits no rotation between the input shaft 21 and the drive gear 35. In addition, while the sleeve 44 moves from the non-mesh position (non-pressing position) to the pressing position, the one-way clutch 37 of the clutch mechanism 41 can transmit the rotation between the input shaft 21 and the drive gear 33. Thus, the control device 14 controls the actuator 45a to move the sleeve 44 from the non-mesh position (non-pressing position) to the pressing position, whereby at least one of the synchronization mechanism 42A and the clutch mechanism 41 constantly transmits power between the input shaft 21 and the output shaft 22 at the time of a gear shift from the 1-speed gear 31 to the 2-speed gear 32.

In the present embodiment, as in the first embodiment, the control device 14 controls the motor generator 11, the synchronization mechanism 42A, and the clutch mechanism 41 so that the acceleration of the vehicle 1 constantly exceeds zero at the time of a gear shift from the 1-speed gear 31 to the 2-speed gear 32 during acceleration of the vehicle 1.

In addition, the control device 14 controls the motor generator 11, the synchronization mechanism 42A, and the clutch mechanism 41 so that at least one of the synchronization mechanism 42A and the clutch mechanism 41 constantly transmits power between the input shaft 21 and the output shaft 22 at the time of a gear shift from the 1-speed gear 31 to the 2-speed gear 32, and that the motor generator 11 constantly generates torque during the period from the operation start points of the synchronization mechanism 42A and the clutch mechanism 41 to the time when the synchronization mechanism is placed in the power transmission state. Specifically, the control device 14 applies voltage to the motor generator 11 during the period from the operation start point of the synchronization mechanism 42A and the clutch mechanism 41 to the time when the cone surface 49b contacts the cone surface 35b, placing the synchronization mechanism 42A in the power transmission state.

As described above, in the present embodiment, the synchronization mechanism 42A and the clutch mechanism 41 commonly use the hub 43, the sleeve 44, and the actuator 45a. This makes it possible to simplify and downsize the structure of the transmission 12.

### Third Embodiment

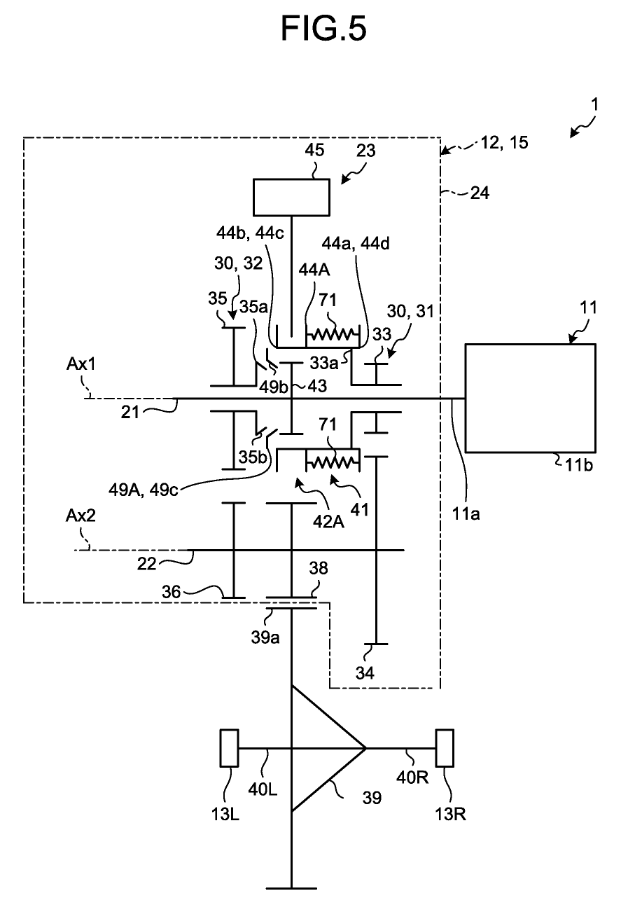

FIG. 5 is an exemplary drawing illustrating a schematic configuration of the vehicle 1 of a third embodiment. The vehicle 1 according to the third embodiment includes a configuration similar to that of the vehicles 1 according to the first and the second embodiments. Thus, the third embodiment also attains similar effects based on the features similar to those of the first and second embodiments. The following will mainly describe different features of the vehicle 1 of the third embodiment from those of the vehicle 1 of the second embodiment.

In the present embodiment, the transmission 12 includes a sleeve 44A instead of the sleeve 44 of the clutch mechanism 41 and the synchronization mechanism 42A according to the second embodiment. In addition, the transmission 12 includes no one-way clutch 37. The sleeve 44A is exemplary first sleeve and second sleeve.

The sleeve 44A includes a 1-speed movable member 44d, a 2-speed movable member 44c, and a plurality of elastic members 71. The 1-speed movable member 44d is an exemplary first movable member, and the 2-speed movable member 44c is an exemplary second movable member.

The 2-speed movable member 44c serves as a sleeve, and includes gear teeth 44b. The 2-speed movable member 4c is located between the drive gear 33 and the drive gear 35.

The 2-speed movable member 44c is coupled with the hub 43 by spline coupling to rotate together around the first rotation axis Ax1, and movable with respect to the hub 43 along the axis of the input shaft 21. That is, the 2-speed movable member 44c rotates around the first rotation axis Ax1 together with the input shaft 21, and is movable with respect to the input shaft 21 along the axis of the input shaft 21. Specifically, the 2-speed movable member 44c is movable along the axis of the input shaft 21 between the 2-speed mesh position, in which the gear teeth 44b are engaged with the gear teeth 35a, and the non-mesh position (FIG. 5), in which the gear teeth 44b are not engaged with the gear teeth 35a. The non-mesh position is closer to the drive gear 33 than the 2-speed mesh position.

In addition, the 2-speed movable member 44c pushes the synchronizer ring 49A to press the cone surface 49b against the cone surface 35b while the 2-speed movable member 44c moves from the non-mesh position to the 2-speed mesh position. Thereby, friction occurs between the cone surface 49b and the cone surface 35b. This position of the 2-speed movable member 44c is the pressing position. By the frictional force, the rotation of the drive gear 35 is synchronized with the rotation of the input shaft 21. After the synchronization, the gear teeth 44b of the 2-speed movable member 44c pass between the gear teeth 49c of the synchronizer ring 49A and engage with the gear teeth 35a of the drive gear 35. The actuator 45a drives the 2-speed movable member 44c. In the present embodiment, the non-mesh position is an exemplary non-pressing position, and the 2-speed mesh position is an exemplary mesh position.

The 1-speed movable member 44d serves as a sleeve, and includes gear teeth 44a. The diameter of the 1-speed movable member 44d is larger than the diameter of the 2-speed movable member 44c. For the sake of convenience, FIG. 5 illustrates the 1-speed movable member 44d and the 2-speed movable member 44c in substantially the same diameter. The 1-speed movable member 44d is coupled with the 2-speed movable member 44c by, for example, spline coupling to rotate together around the first rotation axis Ax1, and is movable with respect to the 2-speed movable member 44c along the axis of the input shaft 21. Thus, the 1-speed movable member 44d rotates around the first rotation axis Ax1 together with the input shaft 21, and is movable with respect to the input shaft 21 along the axis of the input shaft 21. Specifically, the 1-speed movable member 44d is movable along the axis of the input shaft 21 between the 1-speed mesh position, in which the gear teeth 44a are engaged with the gear teeth 33a, and the non-mesh position, in which the gear teeth 44a are not engaged with the gear teeth 33a. The non-mesh position is closer to the drive gear 35 than the 1-speed mesh position. The 1-speed mesh position is an exemplary mesh position, and the non-mesh position is an exemplary non-pressing position.

The elastic members 71 are coil springs. The elastic members are spaced apart from each other around the first rotation axis Ax1 to couple the 1-speed movable member 44d with the 2-speed movable member 44c. While the 2-speed movable member 44d is located in the non-mesh position and the 1-speed movable member 44d is located in the mesh position (FIG. 5), the elastic members 71 generate force (elastic force) to move the 1-speed movable member 44d to the non-mesh position (left side in FIG. 5) from the mesh position. That is, the elastic members 71 generate force that moves the 1-speed movable member 44d toward the 2-speed movable member 44c. The elastic members 71 are an exemplary driver. The number of elastic members 71 may be one. The driver may include an actuator.

In the above configuration, at the time of a gear shift from the 1-speed gear 31 to the 2-speed gear 32, the actuator 45a drives the 2-speed movable member 44c to move from the non-mesh position toward the 2-speed mesh position, and pushes the synchronizer ring 49A to press the cone surface 49b against the cone surface 35b, generating frictional force between the cone surface 49b and the cone surface 35b. This can reduce the rotation speed of the shaft 11a and the rotation speed of the drive gear 33, lowering the power transmitted between the gear teeth 44a of the 1-speed movable member 44d and the gear teeth 33a of the drive gear 33. Thus, by the elastic force of the elastic members 71, the 1-speed movable member 44d is released from the gear teeth 33a of the drive gear 33 and moves to the non-mesh position. Specifically, the elastic members 71 moves the 1-speed movable member 44d to the non-mesh position by elastic force, along with the movement of the 2-speed movable member 44c toward the mesh position to press the cone surface 49b against the cone surface 35b. Thus, the control device 14 controls the actuator 45a to move the 2-speed movable member 44c from the non-pressing position to the pressing position, whereby at least one of the synchronization mechanism 42A and the clutch mechanism 41 constantly transmits power between the input shaft 21 and the output shaft 22 at the time of a gear shift from the 1-speed gear 31 to the 2-speed gear 32.

In the present embodiment, as in the first and second embodiments, the control device 14 controls the motor generator 11, the synchronization mechanism 42A, and the clutch mechanism 41 such that the acceleration of the vehicle 1 exceeds zero at the time of a gear shift from the 1-speed gear 31 to the 2-speed gear 32 during the acceleration of the vehicle 1.

In addition, the control device 14 controls the motor generator 11, the synchronization mechanism 42A, and the clutch mechanism 41 such that at least one of the synchronization mechanism 42A and the clutch mechanism 41 constantly transmits power between the input shaft 21 and the output shaft 22 during a gear shift from the 1-speed gear 31 to the 2-speed gear 32, and that the motor generator 11 constantly generates torque during the period from the operation start points of the synchronization mechanism 42A and the clutch mechanism 41 to the time when the synchronization mechanism is placed in the power transmission state. Specifically, the control device 14 applies voltage to the motor generator 11 during the period from the operation start point of the synchronization mechanism 42A and the clutch mechanism 41 to the time when the cone surface 49b contacts the cone surface 35b, placing the synchronization mechanism 42A in a friction generating state (power transmission state).

As described above, the present embodiment includes the 1-speed movable member 44d (first movable member), the 2-speed movable member 44c (second movable member), and the elastic members 71 (driver). With such a structure, the 1-speed movable member 44d can transmit the rotation between the input shaft 21 and the drive gear 33 while the 2-speed movable member 44c moves from the non-mesh position being the non-pressing position to the pressing position.

The first to third embodiments have described the example that the drive gears 33 and 35 are relatively rotatable with respect to the input shaft 21, and the driven gears 34 and 36 are fixed to the output shaft 22 to rotate together. However, the embodiments are not limited to such an example. Thus, the drive gears 33 and 35 may be fixed to the input shaft 21 to rotate together, and the driven gears 34 and 36 may be relatively rotatable with respect to the output shaft 22. In this case, the output shaft 22 (first shaft) includes the synchronization mechanism 42 or 42A and the clutch mechanism 41. In addition, the driven gear 34 (one) receives the power of the motor generator 11 from the output shaft 22 (the other) through the clutch mechanism 41.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A transmission comprising:
a rotatable first shaft;
a rotatable second shaft parallel to the first shaft;
a first gear pair including a first gear and a second gear, the first gear being attached to the first shaft rotatably with respect to the first shaft, the second gear being attached to the second shaft, to be engaged with the first gear and rotate together with the second shaft;
a second gear pair including a third gear and a fourth gear and being smaller in gear ratio than the first gear, the third gear being attached to the first shaft rotatably with respect to the first shaft, the fourth gear being attached to the second shaft, to be engaged with the third gear and rotate together with the second shaft;
a synchronization mechanism that is switchably placed in a power transmission state and a power shutoff state, the power transmission state being a state that the synchronization mechanism comes between the first shaft and the third gear, and generates frictional force to cause a rotation speed of the first shaft to approach a rotation speed of the third gear, the power shutoff state being a state that the synchronization mechanism generates no frictional force; and
a clutch mechanism that switches a rotation transmission state between the first shaft and the first gear and between the first shaft and the third gear, wherein
the synchronization mechanism comprises:
a first cone surface of the third gear, to rotate together with the third gear;
a synchronizer ring including a second cone surface to be pressed against the first cone surface to generate the frictional force with the first cone surface; and
a first sleeve that is movable between a pressing position and a non-pressing position in an axial direction of the first shaft and rotates together with the first shaft, the pressing position being a position in which the first sleeve presses the second cone surface against the first cone surface, the non-pressing position being a position in which the first sleeve does not press the second cone surface against the first cone surface; and
the first sleeve is movable from the non-pressing position to the pressing position while the clutch mechanism transmits rotation between the first shaft and the first gear and transmits no rotation between the first shaft and the third gear; and
the clutch mechanism transmits rotation between the first shaft and the first gear while the first sleeve moves from the non-pressing position to the pressing position.

2. The transmission according to claim 1, wherein
one of the first shaft and the first gear transmits power of a motor generator to the other of the first shaft and the first gear through the clutch mechanism, and the first shaft and the first gear are rotated in a first rotation direction by the power, and
the clutch mechanism comprises a one-way clutch that is located between the first shaft and the first gear, transmits rotation from the one to the other in the first rotation direction, and allows rotation of the other with respect to the one in the first rotation direction.

3. The transmission according to claim 1, wherein
the first gear pair and the second gear pair are spaced apart from each other in the axial direction of the first shaft,
the clutch mechanism comprises:
first gear teeth that rotate together with the first gear;
second gear teeth that rotate together with the third gear;
a first movable member that:
includes third gear teeth,
is located between the first gear and the third gear and movable between a first mesh position and a first non-mesh position in the axial direction of the first shaft, and
rotates together with the first shaft, the first mesh position being a position in which the third gear teeth are engaged with the first gear teeth, the first non-mesh position being a position in which the third gear teeth are not engaged with the first gear teeth, the first non-mesh position being closer to the third gear than the first mesh position;
a second movable member that:
includes fourth gear teeth,
is located between the first gear and the third gear and movable between a second mesh position and a second non-mesh position in the axial direction of the first shaft,
rotates together with the first shaft, and
presses the second cone surface against the first cone surface while moving from the second non-mesh position to the second mesh position, the second mesh position being a position in which the fourth gear teeth are engaged with the second gear teeth, the second non-mesh position being a position in which the fourth gear teeth are not engaged with the second gear teeth, the second non-mesh position being closer to the first gear than the second mesh position; and
a driver that:
couples the first movable member and the second movable member,
generates force to move the first movable member toward the first non-mesh position while the second movable member is located in the second non-mesh position and the first movable member is located in the first mesh position,
moves the first movable member to the first non-mesh position by the force, along with motion of the second movable member toward the second mesh position to press the second cone surface against the first cone surface.
